(19) United States
(12) Patent Application Publication
(10) Pub. No.: US 2010/0257011 A1
(43) Pub. Date: Oct. 7, 2010

(54) PRECUT MATERIAL ALLOCATING METHOD, COMPUTER PROGRAM FOR THE PRECUT MATERIAL ALLOCATING METHOD, AND COMPUTER-READABLE RECORDING MEDIA

(76) Inventors: Kazuhiro Takeyasu, Osaka (JP); Johsuke Toyoda, Osaka (JP)

Correspondence Address: STITES & HARBISON PLLC, 1199 NORTH FAIRFAX STREET, SUITE 900, ALEXANDRIA, VA, 22314, US

(21) Appl. No.: 12/679,195

(22) PCT Filed: Sep. 19, 2008
(86) PCT No.: PCT/JP2008/067031

§ 371 Date: Mar. 19, 2010

(30) Foreign Application Priority Data
Sep. 21, 2007 (JP) 2007-245815

(51) Int. Cl. G06Q 10/00; G06Q 90/00

(52) U.S. Cl. 705/8; 705/500

(57) ABSTRACT

The present invention provides a precut material allocating method for allocating a plurality of products having a predetermined size to a parent material group composed of a plurality of parent materials of different sizes. The method comprises a sorting step of arraying the plurality of products in order of the sizes; a tentative allocation step of extracting the individual products in the array order and allocating the extracted products tentatively to the individual parent materials belonging to the parent material group, thereby to establish a plurality of tentative allocation states; a first standard step of selecting the tentative allocation state, in which a yield of the parent material used in the allocation is the highest, of the plurality tentative allocation states, as an allocation candidate; a second standard step of selecting the tentative allocation state, in which the total of the remaining sizes of all parent materials used for the allocation is the smallest, of the plurality tentative allocation states, as the allocation candidate; and a third standard step of comparing the selected tentative allocation state and the remaining allocation states, for the tentative allocation states individually selected at the first and second standard steps, if predetermined tentative allocation conditions are satisfied at the first standard step and the second standard step, thereby to select again the tentative allocation state, in which the total of the sizes of the individual parent materials used is the minimum, as the allocation candidate.

### TECHNICAL FIELD

The present invention relates to a precut material assortment processing method of determining the number of raw materials of each cut length having satisfactory yield and which product member to cut out from the respective raw material to cut out a product member of a predetermined length by a predetermined number from the raw material of a plurality of cut lengths, and to a precut material assortment optimization processing method applied when handling a plurality of types of parent materials with a First Fit (FF) method, namely one of Bin Packing Problem (BPP) which is typical combinatorial problem, as a base.

### BACKGROUND ART

A precut material assortment is a problem (Cutting Stock Problem) of cutting out member products of a length required in residential constructions from a plurality of wooden parent materials of different lengths, and can be considered as a one-dimensional Bin Packing Problem (BPP). A capacity of a bin is normally constant in the BPP, but parent materials of different lengths are targeted in precutting.

One example of precut materials is a precut of residential structure materials, where parent materials having different lengths (3.5 m to 6 m) are prepared for every specification such as cross-sectional shape, tree species, and class, and the member (product) of a determined length is cut out therefrom. In the case of a residence of a typical size, an average of ten, and a total of about 200 products are cut out from the parent materials of different lengths for about every 20 types of specifications for horizontal structural members such as a beam, a girder, a base, and the like.

FIG. 1 shows one schematic example of the precut material assortment. A goal of assortment calculation is to cut out required products from as few parent materials (maximum yield) as possible from an assortment result 103 in accordance with a length of a product group 102 according to each length of a parent material group 101 of different lengths prepared for every specification of the product. Minimization of a necessary parent material cost is a goal if a procurement cost and an inventory cost differ depending on the length of the parent material. Normally, maximization of timber volume yield is typically aimed as the parent material cost is determined by a unit price of timber volume. Currently, a primary yield in most precut factories is said to be from about 85% to 90%. For example, Patent Document 1 (Japanese Patent No. 3565262) discloses an allocating method by logic using a computer.

Patent Document 1: Japanese Patent No. 3565262

### DISCLOSURE OF THE INVENTION

### Problems to be Solved by the Invention

In the present invention, an algorithm improved so that a First Fit method, which is one of the easiest and most convenient experimental (heuristic) method in a one-dimensional BBP, can be applied to a precut material assortment problem that handles a plurality of types of parent materials is proposed to carry out a process in a very short calculation time.

### Means for Solving the Problems

The present invention provides a precut material allocating method for allocating a plurality of products having a predetermined size to a parent material group composed of a plurality of parent materials of different sizes, the method including: a sorting step of arraying the plurality of products in order of the sizes; a tentative allocation step of extracting the individual products in the array order and allocating the extracted products tentatively to the individual parent materials belonging to the parent material group, thereby to establish a plurality of tentative allocation states; a first standard step of selecting the tentative allocation state, in which a yield of the parent material used in the allocation is the highest, of the plurality tentative allocation states, as an allocation candidate; a second standard step of selecting the tentative allocation state, in which the total of the remaining sizes of all parent materials used for the allocation is the smallest, of the plurality tentative allocation states, as the allocation candidate; and a third standard step of comparing the selected tentative allocation state and the remaining allocation states, for the tentative allocation states individually selected at the first and second standard steps, if predetermined tentative allocation conditions are satisfied at the first standard step and the second standard step, thereby to select again the tentative allocation state, in which the total of the sizes of the individual parent materials used is the minimum, as the allocation candidate.

Moreover, there is provided the precut material allocating method in which the predetermined tentative allocation conditions of the present invention include checking whether a minimum value of a total size of non-allocated products for each of the established tentative allocation states after tentatively allocating a predetermined number of products to the parent material group is smaller than or equal to a size of a parent material having a largest size belonging to the parent material group at the first and second standard steps, and performing the third standard step if the total size of the non-allocated products is smaller than or equal to the size of the parent material having the largest size, and not performing the third standard step otherwise. Mathematical equation (9), to be described later, is used for the predetermined tentative allocation conditions. In addition, processes by mathematical equations (10), (11) are performed in the third standard step.

Moreover, the first standard step includes a first calculation step of calculating a material yield, obtained by dividing the total size of the products allocated to each parent material used in the tentative allocation by the size of the parent material, for each tentative allocation state established in the tentative allocation step, and a first selection step of selecting the tentative allocation state in which the calculated material yield with respect to each allocation state is the largest as a tentative allocation state in which the yield is the highest.

Further, the second standard step includes a second calculation step of calculating a remaining material size of a portion not allocated with products for each parent material used in the tentative allocation, with respect to each tentative allocation state established in the tentative allocation step, and a second selection step of selecting the tentative allocation state in which the remaining material size is the smallest of the calculated remaining material sizes of each tentative allocation state as a selection candidate.

In addition, the present invention provides the precut material allocating method further including: a first yield calculation step of calculating a yield y1 obtained by dividing a total size of all products to be allocated by the total size of all parent materials used in the tentative allocation, with respect to the allocation candidate selected in the first standard step; a second yield calculation step of calculating a yield y2 obtained by dividing a total size of all products to be allocated by the total size of all parent materials used in the tentative allocation, with respect to the allocation candidate selected in the second standard step; a step of comparing the yield y1 and the yield y2; and an allocation determination step of determining the allocation candidate of larger yield, as a result of the comparison, as the final allocation state.

In the tentative allocation step of the present invention, if a size of one retrieved product is smaller than or equal to a size of one parent material when tentatively allocating the product to the parent material, or the total size of the size of the retrieved product and the sizes of all tentatively allocated products is smaller than or equal to the size of the parent material when one or a plurality of products is already tentatively allocated to the parent material, the retrieved product is tentatively allocated to the parent material. The processes performed in the tentative allocation step are processes shown in Table 2, to be described later.

In the present invention, the sizes of the parent material and the product refer to the length in the one-dimensional direction if the parent material and the product are materials long in the one-dimensional direction.

The parent material and the product may be one-dimensional members or two-dimensional members.

The one-dimensional member may be wood.

The two-dimensional member may be a steel plate, a cloth member, or a paper member etc.

The present invention provides a computer program for implementing the above-described precut material allocating method, and also provides a computer readable recording medium recording such a program.

### EFFECT OF THE INVENTION

In the present invention, the First Fit method, which is one of the easiest and most convenient heuristic method in the one-dimensional BBP, is modified so as to be applied to the precut material assortment problem that handles a plurality of types of parent materials, so that the process can be carried out in a very short calculation time, and the yield can be enhanced when the present invention is applied by residence.

### BRIEF DESCRIPTION OF THE DRAWINGS

FIG. 1 shows one schematic example of precut material assortment.

FIG. 2 shows an FFD method for a plurality of parent materials according to the present invention.

FIG. 3 is a view showing steps in standard 3 according to the present invention.

FIG. 4 is a flow (flowchart) diagram of the entire algorithm of the present invention.

FIG. 5 shows a table of allocation results in residence 1 used in the implementation of the present invention.

FIG. 6 (FIG. 6A and FIG. 6B) is a schematic flowchart of a material allocating method of the present invention.

### DESCRIPTION OF REFERENCE NUMERALS

101 parent material group
102 product group
103 assortment result

### BEST MODE FOR CARRYING OUT THE INVENTION

In the following examples, a parent material is a one-dimensional member, for example, a wood that is long in one direction. The size is reread as length.

A parent material group is composed of a plurality of parent materials having different lengths from each other. The parent material is prepared in great numbers such that all products to be allocated can be allocated.

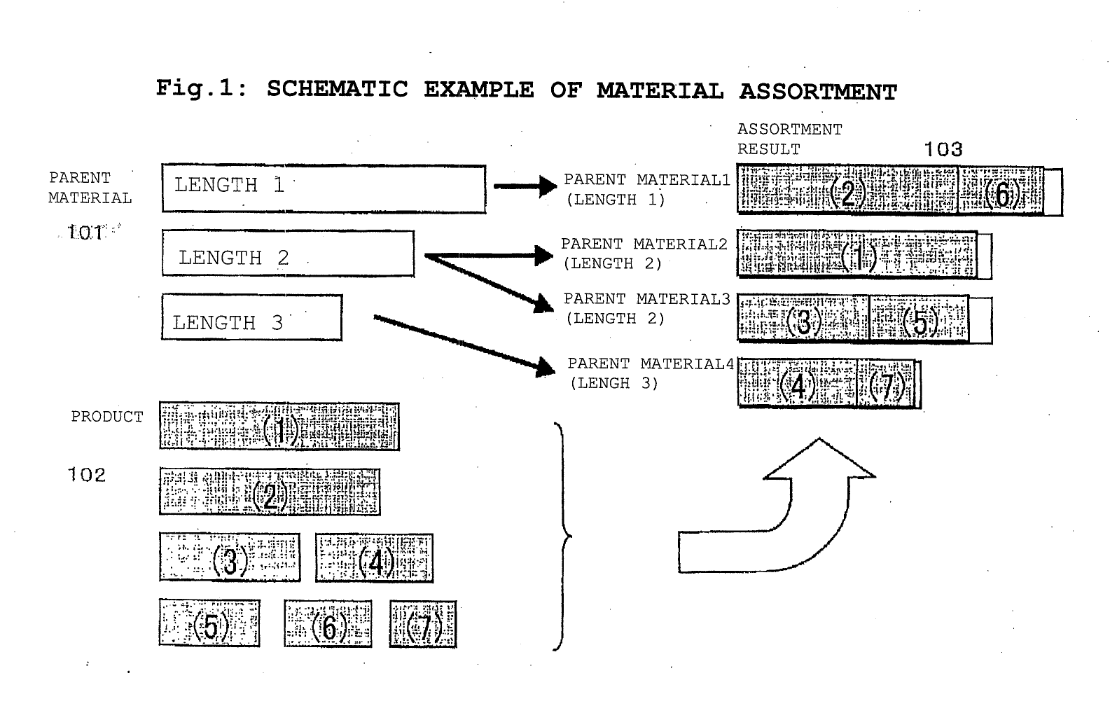

In FIG. 1, for example, the parent material group is composed of three parent materials 101 of different lengths. The product is a member that is actually used, and refers to a member having a required length.

For example, if a column necessary to build a house is the product and a length of the column requires four types, four columns of different lengths need to be cut out from the parent material as the product (column).

If a plurality of products of the same length is required, the products are allocated to the parent materials by the necessary number. A plurality of products having a predetermined size refers to, for example, seven products 102 of different lengths shown in FIG. 1.

The parent material group and the product are determined in advance before executing the allocating method of the invention. Specifically, data of the parent material group (identification information of each parent material, information on length thereof, etc.) and data of each product (identification information of each product, information on length, etc.) are inputted to a computer, and saved in a memory such as a hard disk before executing the allocating method with the computer such as a personal computer.

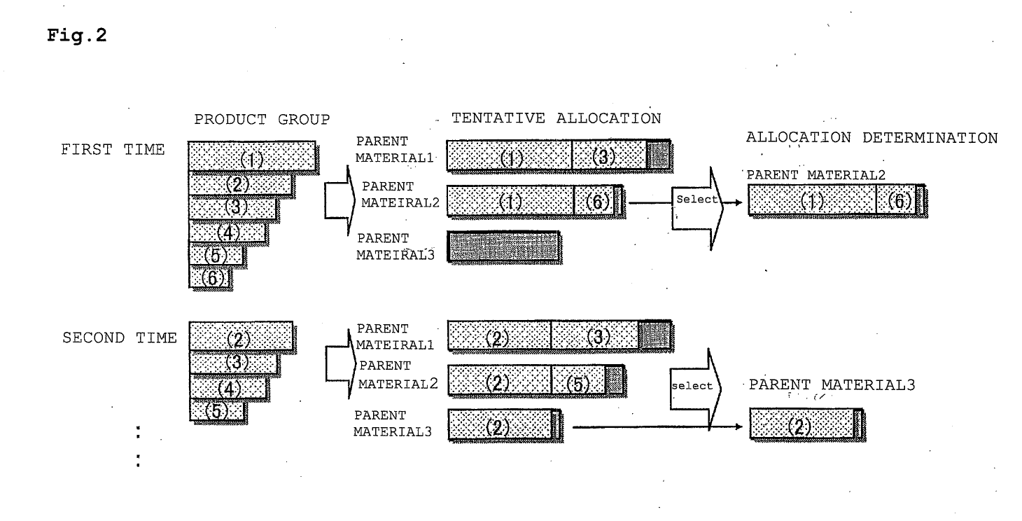

In a sorting step of the invention, the plurality of products is arrayed in descending order of length. For example, the product groups (1) to (6) of FIG. 1 are sorted in the descending order of length, as in (1) to (6) of FIG. 2.

The sorting step is executed using the inputted data of the product. The data of the products, which are sorted in the length order, are fixed and stored in the memory, and the step is executed only once.

Thus, the sorting does not need to be performed again in first and second standard steps by storing the sorted result in the memory.

In a tentative allocation step, a process of allocating the products retrieved from the memory is performed for one certain parent material. The allocation means selecting a parent material from which the product can be cut out, where the information of the product and the information of the parent material are associated and stored in the memory so that the allocation can be recognized after tentative allocation. If there is a plurality of types parent materials, the retrieved products are respectively allocated to the parent materials of different type. The product is retrieved in the descending order of length sorted in the sorting step. Therefore, the longest product is retrieved first.

The process of allocating one retrieved product to the parent materials of different lengths is repeatedly carried out. For example, as shown in FIG. 2, two tentative allocation states, of a state in which the product (1) is tentatively allocated to the parent material 1 and a state in which the same product (1) is tentatively allocated to the parent material 2, are established with respect to the retrieved product (1) in the first tentative allocation.

In other words, if there are N parent materials to which one retrieved product can be allocated, N tentative allocation states are established. The tentative allocation step is performed in a first standard step and a second standard step, as hereinafter described, and is specifically a portion of performing the process shown in Table 2, as hereinafter described.

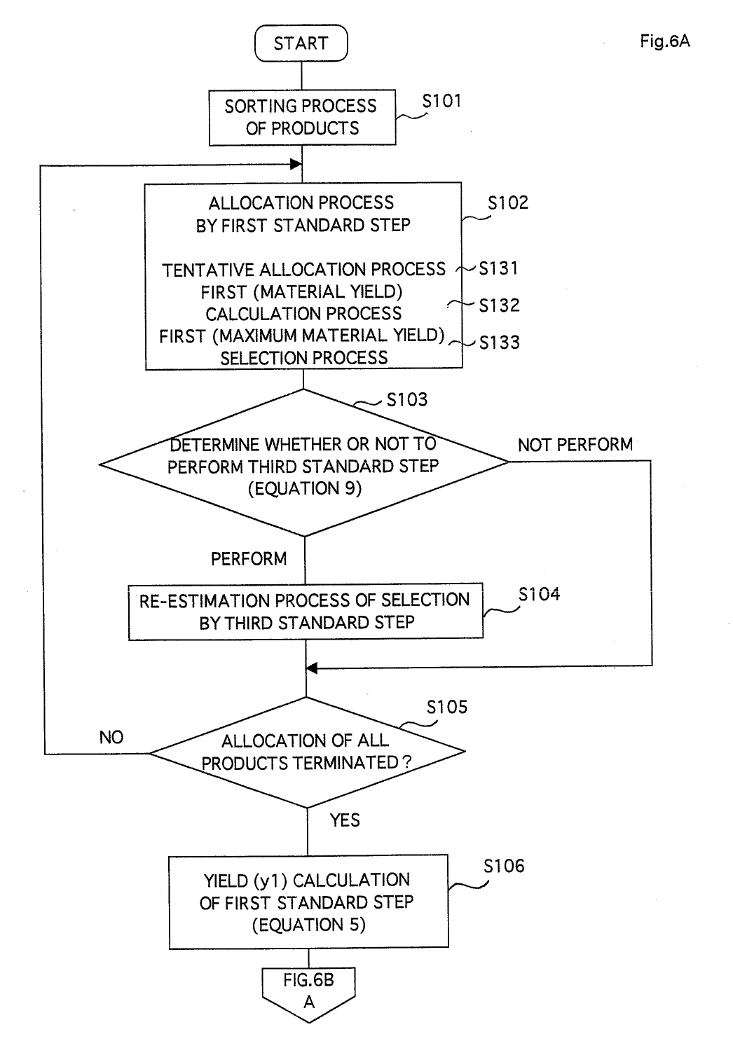

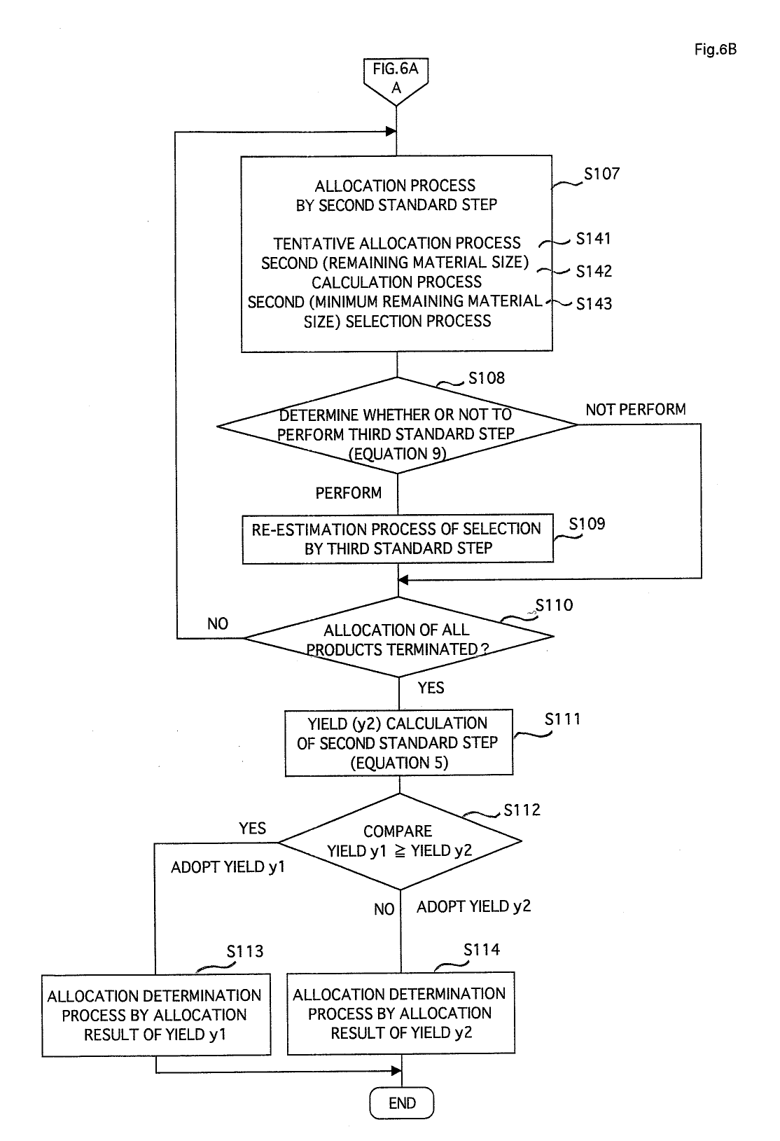

FIG. 6 (FIG. 6A and FIG. 6B) shows a schematic flowchart for describing an outline of a material allocating method of the present invention.

First, in step S101, the sorting step is executed. The data of the product group sorted in the descending order of length is thereby obtained (see FIG. 2).

The first standard step (step S102) is then executed.

Here, the tentative allocation state in which a yield of the parent material used in the allocation is the highest is selected as an allocation candidate. For example, as shown in FIG. 2 to be described later, the allocation state of the parent material 2 of the two tentative allocation states (parent material 1, parent material 2) is selected as the allocation candidate in the first tentative allocation.

In the first standard step, a first calculation step (step S132) and a first selection process (step S133) are executed in addition to the tentative allocation process (step S131).

In a first calculation process, a material yield is calculated.

The material yield is a numerical value obtained by dividing the total size of the products allocated to one certain parent material by the size of the relevant parent material, and is calculated for every parent material used in the tentative allocation. For example, as shown in FIG. 2, two parent materials 1 and 2 are selected in the first tentative allocation, and the material yield is calculated for each of the two parent materials.

In the first selection process, the parent material having the maximum material yield is selected as the tentative allocation state of highest yield if the calculated material yield is in plurals.

For example, in the first tentative allocation of FIG. 2, the material yield with a larger value (i.e., parent material 2) of the material yields calculated with respect to the two tentative allocation states (parent material 1, parent material 2) is selected.

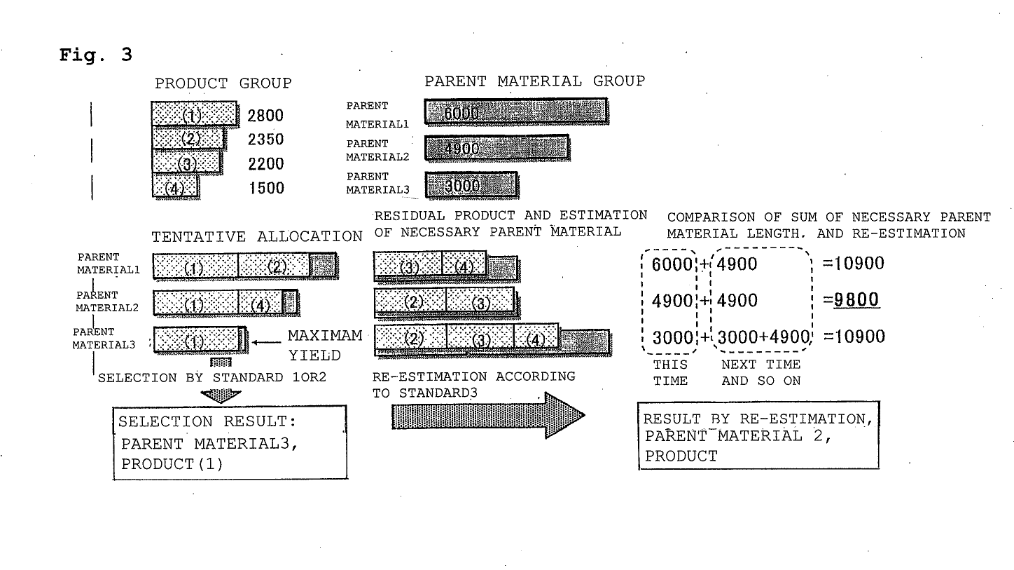

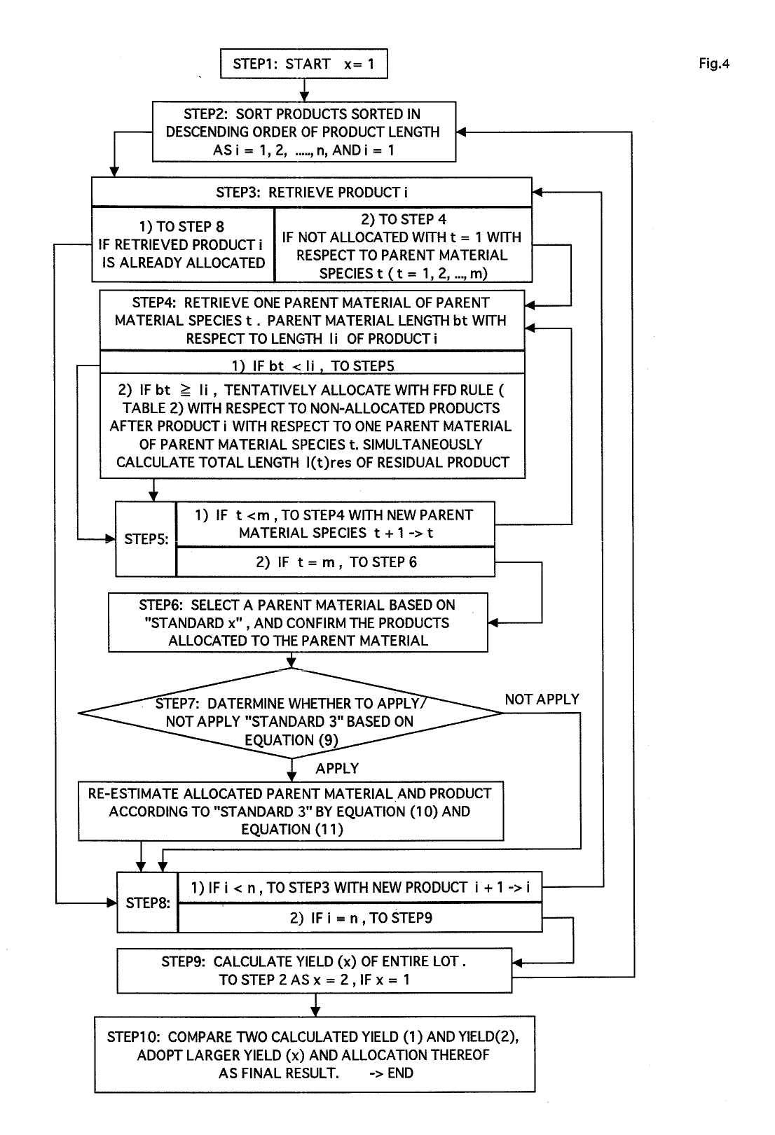

In the tentative allocation of FIG. 3, the tentative allocation state (parent material 3) having the maximum material yield is selected from the three tentative allocation states (parent material 1, parent material 2, parent material 3). The selected tentative allocation state is stored in the memory as the allocation candidate of the first standard step.

In step S103, whether or not to perform a third standard step is determined.

The predetermined tentative allocation conditions described above is used, and specifically, equation (9) to be described later is used for such determination. In the case of FIG. 3 to be described later, the determination is made in the following method.

In FIG. 3, three tentative allocation states (parent material 1, parent material 2, parent material 3) are established. The non-allocated products for the parent material 1 (first tentative allocation state) are products (3) and (4), the non-allocated products for the parent material 2 (second tentative allocation state) are products (2) and (3), and the non-allocated products for the parent material 3 (third tentative allocation state) are products (2), (3), and (4). The smallest sum of the sizes (lengths) of the products that are not yet allocated is the sum of the lengths (3700) of the products (3) and (4) of the first tentative allocation state in FIG. 3 with respect to the three parent materials.

In other words, the total length (3700) of the products (3) and (4) is shorter than the total length (4550) of the products (2) and (3), and shorter than the total length (6050) of the products (2), (3), and (4).

If the total size (length) of the non-allocated products (3) and (4) is shorter than the length (6000) of the parent material 1 having the largest size (length) in the parent material group, the predetermined tentative allocation conditions is satisfied.

If the condition is satisfied, the process proceeds to step 104, and the third standard step is executed.

If the condition is not satisfied, the process proceeds to step 105, and whether or not the tentative allocation of all products inputted in advance is terminated is determined. The process proceeds to step 106 if the tentative allocation of all products is terminated.

In step 104, which one of the allocation candidate selected in the first selection process or the other non-selected tentative allocation state is appropriate is determined based on the specific standard defined in the third standard step to again select the allocation candidate.

The specific standard is the standard of calculating the sum of the sizes (lengths) of each parent material used and selecting that of the shortest sum of the sizes (lengths) with respect to a certain tentative allocation state. Specifically, equations (10) and (11) to be described later correspond to such a standard.

The parent material to allocate the non-allocated product needs to be selected to perform the calculation of equation (10) described later. Equations (7) and (8), described later, are used for such selection.

For example, in the first tentative allocation state of FIG. 3, the products (1) and (2) are tentatively allocated to the parent material 1, and the non-allocated products (3) and (4) can be allocated to one parent material 2, and thus the parent material 2 is selected by equation (8).

In the second tentative allocation state of FIG. 3, the products (1) and (4) are tentatively allocated to the parent material 2, and the non-allocated products (2) and (3) can be allocated to one parent material 2.

Furthermore, in the third tentative allocation state of FIG. 3, the product (1) is allocated to the parent material 3, but the parent material 2 and the parent material 3 are necessary to allocate all non-allocated products (2), (3), and (4). In this case, two parent materials (2, 3) are selected to allocate three non-allocated products.

After selecting the parent material necessary for allocating all residual non-allocated products, a process of having the tentative allocation state, in which the total length of the lengths of the parent material already selected in the tentative allocation process and the lengths of the parent material to be used for the non-allocated products selected in the above-described selection becomes a minimum, as the allocation candidate is performed.

For example, the sum of the lengths of each parent material to use is calculated for each three tentative allocation states in FIG. 3. In the first tentative allocation state, the products (1) and (2) are allocated to the parent material 1, and the residual products (3) and (4) are allocated to the parent material 2. In this state, the parent material 1 and the parent material 2 are used, and thus the total lengths (6000+4900=10900) of the parent material 1 and the parent material 2 to use is calculated.

Similarly, in the second tentative allocation state, which is not an allocation candidate, two parent materials 2 are the parent materials to use, and the total lengths of the parent materials to use is 4900×2=9800.

In the third tentative allocation state, which is the allocation candidate in the tentative allocation process, two parent materials 3 and one parent material 2 are the parent materials to use, and the total lengths of the parent materials to use is 3000×2+4900=10900.

In this case, the smallest of the three calculated total lengths is the second tentative allocation state, and thus the second tentative allocation state, in which the total size is the smallest, is re-selected as the allocation candidate. The information stored in the memory as the allocation candidate is replaced with the information of the second tentative allocation state of after re-estimation of selection.

In other words, in step S104, the allocation candidate selected in step S133 is changed to another tentative allocation state by executing the third standard step. However, the allocation candidate may not be changed even if re-estimation by the third standard step is performed.

When re-estimation of selection by the third standard step is executed, the allocation using the first standard step of all products is terminated.

In step S106, a first yield calculation step is executed.

Specifically, calculation by mathematical equation (5) described later is performed. The entire yield (y1) on all parent materials used with all the products, which allocation is terminated in the first standard step, is obtained.

Therefore, the allocation of products assumed as appropriate by the first standard step is terminated, and the allocation result thereof is stored in the memory. The allocation result includes the yield (y1), the data of the parent materials to be used, and the data of the products associated with each parent material.

In step S107, the allocation process by the second standard step is performed.

The processing contents of the tentative allocation process of step S141, and the subsequent steps S108, S109, and S110 are similar to those of steps S131, S103, S104, and S105.

A second calculation process in step S142 differs from step S132 in that the remaining material size (length) of the portion not allocated with a product is calculated with respect to one tentative allocation state for each parent material used in the relevant tentative allocation, instead of the material yield being calculated.

Describing with the case of FIG. 2, two tentative allocation states (parent material 1, parent material 2) are established in the first tentative allocation, and the remaining material length is calculated for the parent materials of the respective tentative allocation state. For example, the products (1) and (3) are tentatively allocated to the parent material 1 of FIG. 2, and the remaining material length of the parent material 1 is obtained by subtracting the total lengths of the products (1) and (3) from the length of the parent material 1.

Similarly, with respect to the parent material 2, the remaining material length of the parent material 2 is obtained by subtracting the total lengths of the products (1) and (6) from the length of the parent material 2. Two remaining material lengths are calculated herein.

In the next second selection step (step S143), the tentative allocation state having the smallest remaining material size (length) of the calculated remaining material sizes (lengths) is selected as the selection candidate.

In the case of FIG. 2, the tentative allocation state of the parent material 2 is selected as the selection candidate since the remaining material size (length) is shorter in the parent material 2 of the two tentative allocation states (parent material 1, parent material 2).

Thereafter, similar to the first standard step, the processes of steps S108, S109, and S110 are performed, and the tentative allocation state in which the total of the remaining sizes on all parent materials used in the allocation of all products becomes the smallest is selected as the allocation candidate. However, if the third standard step (step S109) is performed, the allocation candidate may be changed to a different tentative allocation state.

In step S111, the yield (y2) is calculated with respect to the selection candidate selected by executing the second standard step. The content of the yield calculation is the process similar to step S106.

Furthermore, in step S112, the two calculated yields y1 and y2 are compared, and the allocation candidate with a larger numerical value is determined as the final allocation state (steps S113, S114). The information (data of parent material and product) indicating the determined allocation state is saved in the memory, and printed and displayed, as necessary.

The flow of FIG. 6 (FIG. 6A and FIG. 6B) as described above shows the outline of the entire processes performed in the allocating method of the present invention. The processes same as the entire processes of FIG. 6 are shown in a different mode in Table 1 and FIG. 4, to be described later.

In FIG. 6 (FIG. 6A and FIG. 6B) and Table 1, step S101 mainly corresponds to Steps 1 and 2, and steps S102 and S107 mainly correspond to Steps 3 to 6. Furthermore, steps S131 and S141 correspond to Steps 3 to 5, and steps S132 and S133 correspond to Step 6. Moreover, steps S142 and S143 also correspond to Step 6.

Steps S103 and S104, and S108 and S109 correspond to Step 7.

Steps S105 and S110 correspond to Step 8.

Steps S106 and S111 correspond to one part of Step 9.

Steps S112, S113, and S114 correspond to Step 10.

The processes and measurement results to be described in the following example are obtained by implementing the outline process shown in FIG. 6 (FIG. 6A and FIG. 6B).

The sorting process (step), the tentative allocation process (step), the processes of the first standard step, the second standard step and the third standard step, the first and second calculation processes (steps), first and second selection processes (steps), first and second yield calculation processes (steps), the comparison process (step), and the allocation determining process (step) shown in FIG. 6 (FIG. 6A and FIG. 6B) are executed by a computer such as a personal computer mounted with a microcomputer.

The function of each process is implemented by a microcomputer including a CPU, a ROM, a RAM, an I/O controller, a timer, and the like, and is implemented when the CPU executes various types of hardware based on the program saved in the memory such as the RAM and the hard disk.

The program for implementing the material allocating method of the present invention may be provided by being fixed and recorded in a semiconductor memory element such as the ROM, or may be provided by being saved in a portable recording medium such as a CD-ROM, a DVD, a flash memory, and the like. Furthermore, the program may be saved in a server of a remote location, and provided by being downloaded to a terminal such as a personal computer through a network such as the Internet.

The precut CSP can be modeled as a one-dimensional BPP, where a BPP normally handles a bin of one type of capacity but the present precut CSP has different parent material lengths and is universal in terms of assuming a bin of a plurality of capacities. Assuming that GA is applied for every product group having an identical cross-sectional shape, tree species, and class specification, a one-dimensional multi-BPP that handles a plurality of types of bins will be defined first.

If the bins of m types of capacities bₜ (t=1, . . . , m) are sufficiently provided, and the items of capacity lᵢ (i=1, . . . , n) are to be all placed therein, the one-dimensional multi-BPP can be expressed as below with the usage cost of the bin of bin type t of the capacity bₜ as cₜ, and the bin type of the bin k (k=1, 2, . . . ) as tₖ.

$$[ Equation 1 ]$$

$$\begin{matrix}min {\sum }_{k ∈ B} {c}_{{t}_{k}} \\ [ Equation 2 ] & ( 1 ) \\ subject to {\sum }_{i ∈ {I}_{k}} {l}_{i} \leq {b}_{{t}_{k}} {}^{∀} k ∈ B \\ [ Equation 3 ] & ( 2 ) \\ {⋃}_{k ∈ B} {I}_{k} = I \\ [ Equation 4 ] & ( 3 ) \\ {I}_{{k}_{1}} ⋂ {I}_{{k}_{2}} = φ {}_{}^{∀}{k}{}_{1}^{} , {k}_{2} ∈ B , {k}_{1} \neq {k}_{2} \\ [ Equation 5 ] \\ Where {I}_{k} : set of items to place in bin k \\ I = : set of all items to place in the bin \\ {B}_{t} = \{ k \vert {I}_{k} \neq φ , {t}_{k} = t \} : set of bins of used bin type t \\ B = {⋃}_{t = 1}^{m} {B}_{t} : Set of used bins & ( 4 )\end{matrix}$$

Equation (2) indicates that the total capacity of the items to be placed in the bin is smaller than or equal to the capacity of the bin, equation (3) indicates that all items are placed in one of the bins, and equation (4) indicates that one item cannot be simultaneously placed in a plurality of bins.

The precut CSP is obtained by replacing the bin with the precut parent material, the set of bins by capacity with the set of parent materials by length (hereinafter denoted as parent material species), and the item to place in the bin with the product to cut out, and changing the reading of capacity to length. The precutting normally aims to obtain a maximum yield. The yield y is expressed with the following equation.

$$[ Equation 6 ]$$

$$y = {\sum }_{i ∈ I} {l}_{i} / {\sum }_{k ∈ B} {b}_{{t}_{k}} \qquad ( 5 )$$

Since the cumulative total of the product lengths at the numerator is given, the usage cost cₜ can be replaced with the parent material length bₜ in equation (1) to obtain:

$$[ Equation 7 ]$$

$$min {\sum }_{k ∈ B} {b}_{{t}_{k}} \qquad ( 6 )$$

In the precutting, the “notch” (cutout at both ends to align the shape of both ends of the parent material) for aligning both ends of the parent material and the “saw margin” (thickness of saw that gets lost as chips in time of cutting) when cutting out the product are to be considered, but are not essential problems.

The First Fit method in the general BPP is a solving method of examining whether or not a space for placing an item is present in order always from a left, for example, of lined bins, and fitting the item to the bin with a necessary space that is found first. If the orders of target products (items) are all known in advance, all the products are sorted in descending order of size (length), and the bin with the necessary space is searched in such order and then fitted (First Fit Descending: FFD), which leads to more satisfactory result than random fitting.

The FFD in the one-dimensional BPP is an algorithm of searching in order the bins having room to place the items taken out in descending order of size, and allocating the item to the bin found first (if bin is not found, new bin). Reviewing such an aspect from the view of the bin, the items that can be fitted are placed in the descending order of size before the bins become full. The FFD cannot be used as is since the length of the parent material (capacity of the bin) has a plurality of types in the present model. The following algorithm is thus considered.

The operation of allocating the products sorted in the descending order of length to one parent material of the respective parent material species with the FFD rule, and adopting the parent material with the most “satisfactory allocation” and the relevant allocation is repeated until all products are allocated. In this case, the first longest product is always allocated. This is based on the idea that leaving the long products towards the ends is not appropriate.

FIG. 2 is a schematic view of the FF (First Fit) method according to the present invention. Here, the allocation to the parent material 3 is not performed since the parent material 3 is shorter than the product (1) in the first allocation.

The FFD is an algorithm for performing the allocation assumed to be optimum at different times, and does not perform the allocation in consideration of an overall view, and thus the bin of unsatisfactory yield tends to produce in a final stage. In the present model, how well to select a target parent material from a plurality of parent material species and raise the entire yield utilizing the fact that a plurality of parent material species is being handled is considered. First, selection criteria on “satisfactory allocation” to the parent material are set as below.

Standard 1: yield standard . . . allocation of highest yield

Standard 2: remaining material length standard . . . allocation in which the remaining material length of the parent material is the shortest

The standards 1 and 2 are the same if the parent material species is only one, but differ if in plurals. The yield of the entire allocation is given with equation (5), where “standard 1” provides a selection in which the highest yield is obtained at a relevant time point in a certain allocation step. Assuming that the total parent material length at the denominator, which is first the total product length, changes to the total parent material length and the total residual products as a sequence of products gets replaced with the parent materials, the “standard 2” is the selection criterion with least amount of increase. Although the “standard 1” is generally considered more rational since the “standard 2” does not take into consideration the ratio with the length of the replaced product, the “standard 1” may not necessarily give a satisfactory result over the “standard 2” since the FFD does not perform the allocation in consideration of the overall view, as mentioned above. The present model thus adopts the allocation in which satisfactory result is obtained when executed at the respective standard.

The next “standard 3” is provided to avoid even a slight “tendency the bin of unsatisfactory yield produces in the final stage”, which is a characteristic of the FFD, and the selection result according to the “standard 1” or the “standard 2” is re-estimated according to the “standard 3”.

Standard 3: Parent material length standard . . . the allocation “standard 3” in which the parent material necessary for the allocations after the relevant allocation becomes a minimum achieves a goal of equation (6) if applied to all allocations, but cannot be applied unless the entire allocation can be taken into consideration. Application is made at a stage the final allocation with respect to the non-allocated product can be viewed overall. Assuming the sum of the lengths of the products that are not yet allocated as a result of tentative allocation to the parent material of parent material species t at a certain stage is l^{(t)}ᵣₑₛ, b^{(t)} is defined as below.

$$[ Equation 8 ]$$

$$\begin{matrix}{b}^{( t )} = \{ \begin{matrix}0 & when {l}_{res}^{( t )} = 0 \\ {min}_{s = 1 , … , m} \{ {b}_{s} \vert {l}_{res}^{t} ≦ {b}_{s} \} & when 0 < {l}_{res}^{( t )} \leq {b}_{max} \\ {b}_{min} \times 2 & {b}_{max} < {l}_{res}^{( t )} ≦ max ( {b}_{max} , {b}_{min} \times 2 ) \\ {b}_{min} + {b}_{min + 1} & max ( {b}_{max} , {b}_{min} + {b}_{min} ) < {l}_{res}^{( t )} \\ & ≦ max ( {b}_{max} , {b}_{min} + {b}_{min + 1} ) \\ {l}_{res}^{( s )} & {l}_{res}^{( s )} > max ( {b}_{max} , {b}_{min} + {b}_{min + 1} )\end{matrix} \\ [ Equation 9 ] & ( 7 ) \\ Where {b}_{max} = {max}_{s = 1 , … , m} {b}_{s} , {b}_{min} = {min}_{s = 1 , … , m} {b}_{s} , {b}_{min + 1} = {min}_{s = 1 , … , m} \{ {b}_{s} \vert {b}_{s} > {b}_{min} \} & ( 8 )\end{matrix}$$

Here, b^{(t)} is the “sum of the lengths of the parent materials at least necessary to allocate all residual products when allocated to the parent material of parent material species t”. In particular, if 0<l^{(t)}ᵣₑₛ≦bₘₐₓ, this means that all residual products can be allocated to the parent material of the length in the next allocation b^{(t)}. If bₘₐₓ<l^{(t)}ᵣₑₛ, all accurate necessary parent materials cannot be viewed overall, but the allocation can be terminated by using the parent materials of the respective combinations in the allocation of the next time and the time after that if l^{(t)}ᵣₑₛ is the combination of two or more parent materials and is smaller than or equal to the shortest combination (bₘᵢₙ+bₘᵢₙ), or the next shortest combination (bₘᵢₙ+bₘᵢₙ₊₁).

Assume that the parent material of the parent material species t_{d} is selected as a result of applying “standard 1” or “standard 2” in the tentative allocation to the product group having the product i of a certain stage as the lead. With respect to the total length l^{td}ᵣₑₛ of the residual product by the selection and the l^{t}ᵣₑₛ obtained in the allocation to the parent material of the other allocatable parent material species t, the re-estimation according to the “standard 3” is performed from the time point of:

$$[ Equation 10 ]$$

$${l}_{res}^{{t}_{d}} > 0 and {min}_{t ∈ {B}^{+ i}} {l}_{res}^{t} ≦ {b}_{max} where {B}^{+ i} = \{ t \vert {b}_{t} \geq {l}_{i} \} \qquad ( 9 )$$

The second half of the condition means that the allocation to at least one parent material refers to that the stage the final allocation with respect to the residual products can be viewed overall is reached.

The re-estimation is carried out in the following manner. In the tentative allocation to the product group having the product i as the lead, with respect to the length bₜ of the parent material of the parent material species t and the b^{(t)} calculated in equation (7), the allocation to the parent material of to selected first is re-estimated and the allocation to the parent material of the parent material species tₘᵢₙ is adopted (FIG. 3) if (11) with respect to tₘᵢₙ of (10).

[Equation 11]

tₘᵢₙ=min{s|bₛ+b^{(s)}≦bₜ+b^{(t)}, for ∀tεB⁺ⁱ} (10)

[Equation 12]

tₘᵢₙ≠t_{d} (11)

FIG. 3 shows the third procedure step according to the standard 3 of the present invention, where tₘᵢₙ of equation (10) refers to the parent material species of the parent material in which the sum of the lengths of the parent material allocated this time and the parent material to be allocated the next time and so on becomes shorter, and equation (11) means that it is not the parent material species to selected according to the “standard 1” or the “standard 2”.

This can be summarized in the flow of the following processes (shown in Table 1). The yield of the entire lot obtained by the process of selecting according to the “standard x” (x=1, 2) and re-estimating according to the “standard 3” is expressed as yield (x).

TABLE 1
<Modified FFD algorithm>

```
  Step 1: Set x = 1.
  Step 2: Set sequence of products sorted in descending order of product
length as i = 1, 2, . . . , n, where i = 1.
  Step 3: Retrieve product i. To step 8 if retrieved product i is already
allocated. To step 4 if not allocated with t = 1 with respect to parent
material species t (t = 1, 2, . . . , m).
  Step 4: Retrieve one parent material of parent material species t. Parent
material length bₜ with respect to length lᵢ of product i, if bₜ < lᵢ, to step 5; if
bₜ ≧ lᵢ, tentatively allocate with FFD rule (Table 2) with respect to non-
allocated products after product i with respect to one parent material of
parent material species t. Simultaneously calculate total length l^{(t)}ᵣₑₛ of
residual products
  Step 5: To step 4 with new parent material species t + 1→ t if t < m. To
step 6 if t = m (tentative allocation is terminated for all parent material
species).
  Step 6: Select a parent material based on “standard x”, and confirm the
products allocated to the parent material.
  Step 7: Determine whether to apply/not apply “standard 3” based on
equation (9) Re-estimate allocated parent material and product according
to “standard 3” by equation (10) and equation (11) if applied.
  Step 8: To step 3 with next product i + 1→ i if i < n. To step 9 if i = n.
  Step 9: Calculate yield (x) of entire lot. To step 2 as x = 2 if x = 1.
  $Step 10 \text{:} Compare two calculated yields , and have {max}_{x = J , 2} yield ( x ) and$
allocation thereof as final result.
```

Table 2 shows the FFD allocation rule with respect to one parent material.

TABLE 2
<FFD allocation rule with respect to one parent material>

Assume the length of the parent material to allocate as b, the set of

products to be allocated to the parent material as I, the sequence of the
products sorted in the descending order of length as i = 1, 2, . . ., n, and
the product length of the product i as lᵢ. The set of allocated products is Iₐ.

Step 1: Set i '2 1.
Step 2: Retrieve product i. To step 4 if retrieved product i is already

allocated.

Step 3: Allocate product i to parent material if following equation is

met with respect to non-allocated product i.

| | |
|---|---|
| | (12) |
| ${\sum }_{j ε {l}_{n}} {l}_{j} + {l}_{i} ≦ b$ | |

Step 4: To step 2 as next product i + 1 → i if i < n. Terminate

allocation if i = n.

FIG. 4 is a flowchart showing Table 1.

Although the disadvantage of the First Fit method is that the allocation does not consider the overall view, the present algorithm performs tentative allocation with respect to the parent material of a plurality of parent material species, and compensates for such disadvantage by

(1) executing at two standards (“yield standard” and “remaining length standard”), and adopting the allocation result to the parent material with satisfactory result;

(2) comparing the sum of the lengths of the parent material used this time and the parent material to allocate the next time or so on for each parent material at a stage the completion of the entire allocation can be expected in the next allocation with respect to the non-allocated products, and re-estimating the parent material adopted in (1).

### First Example

A modified FFD of the present application (referred to as present application FFD) was performed on horizontal structural members of a standard wooden house, which order a housing manufacturing company received. Such horizontal structural members can be grouped into about 20 lots that can be cut out from the same parent material such as a cross-sectional size, tree species, and class, where the number of products to cut out and the parent material group to use differ for each lot. The present application FFD was applied for every lot. The notch was set to 0 mm and the saw margin to 5 mm.

The algorithm of Patent Document 1 (referred to as conventional method) disclosed for comparison is applied. The relevant algorithm is a method including a step of listing up combinations of parent materials of a plurality of parent material lengths that becomes greater than or equal to a total length with respect to the total length of all products, and determining whether all products can be allocated in the ascending order of the sum of the parent material lengths in the listed combinations of parent materials; and a step of searching for the combination of parent materials in which the sum of the parent material lengths becomes small with respect to the combinations of minimum sum of the parent material lengths that can be allocated.

Comparison of execution results on data for a residence 1 including 16 lots, 201 horizontal structural member products and for a residence 2 including 18 lots, 199 horizontal structural member products is shown in Table 1. An execution time of the modified FFD in the personal computer having the specification shown in FIG. 3 is about one second until the completion for all lots of one residence. The conventional method is the result of an actual operation system by another personal computer and cannot be precisely compared, but the processing time of the assortment calculation portion is assumed to be about few minutes.

The superiority with the conventional method differs for each lot, but results by no means inferior were obtained as a whole. The entire timber volume yield was 93.37% with the conventional method and 93.80% with the present application FFD with respect to the residence 1, and 94.60% with the conventional method and 94.45% with the present application FFD with respect to the residence 2.

The result of comparing the entire timber volume yield is shown in Table 3 for ten wooden housings including the above. In data for ten residences, the present application FFD was superior for all except residence 2, and the yield superiority of substantially 1% was obtained in residence 5 and residence 6.

TABLE 3
Comparison of allocation result (by lot)

| | | Cross- | | | Product | | Parent | Yield | |
|---|---|---|---|---|---|---|---|---|---|
| Name of | | sectional | Tree | | | Timber | material | Present application | Conventional |
| residence | Lot | shape | species | Class | Number | volume (m³) | Length type | FFD | method |
| Residence 1 | 1 | 105 × 105 | 323 | 292 | 37 | 0.9868 | 3 | 93.74% | 92.04% |
| | 2 | 105 × 105 | 801 | 292 | 18 | 0.5430 | 3 | 96.26% | 96.26% |
| | 3 | 270 × 105 | 328 | 294 | 3 | 0.3035 | 5 | 89.97% | 89.97% |
| | 4 | 240 × 105 | 328 | 294 | 17 | 1.5129 | 6 | 95.75% | 95.75% |
| | 5 | 210 × 105 | 328 | 293 | 4 | 0.3429 | 5 | 92.02% | 92.02% |
| | 6 | 180 × 105 | 328 | 293 | 11 | 0.4887 | 5 | 94.36% | 94.36% |
| | 7 | 150 × 105 | 328 | 293 | 1 | 0.0138 | 5 | 29.13% | 29.13% |
| | 8 | 120 × 105 | 328 | 293 | 36 | 0.5726 | 5 | 96.89% | 97.51% |
| | 9 | 105 × 105 | 328 | 292 | 9 | 0.2154 | 3 | 92.84% | 92.84% |
| | 10 | 210 × 105 | 328 | 293 | 6 | 0.4425 | 5 | 95.56% | 95.56% |
| | 11 | 150 × 105 | 328 | 293 | 8 | 0.3719 | 5 | 92.97% | 90.82% |
| | 12 | 120 × 105 | 328 | 293 | 3 | 0.1065 | 5 | 94.94% | 93.89% |
| | 13 | 105 × 105 | 328 | 292 | 24 | 0.5261 | 3 | 95.82% | 95.82% |
| | 14 | 90 × 90 | 49 | 7 | 16 | 0.3312 | 2 | 92.94% | 90.87% |
| | 15 | 105 × 105 | 49 | 7 | 2 | 0.0492 | 2 | 63.71% | 63.71% |
| | 16 | 90 × 90 | 49 | 7 | 6 | 0.0953 | 2 | 90.48% | 90.48% |
| | | | | | 201 | 6.9021 | | 93.80% | 93.37% |
| Residence 2 | 1 | 105 × 105 | 323 | 292 | 38 | 0.8881 | 3 | 95.76% | 95.67% |
| | 2 | 105 × 105 | 801 | 292 | 13 | 0.2910 | 3 | 96.34% | 96.34% |
| | 3 | 240 × 105 | 328 | 294 | 14 | 1.0869 | 6 | 97.36% | 96.27% |
| | 4 | 210 × 105 | 328 | 293 | 5 | 0.3275 | 5 | 92.82% | 92.82% |
| | 5 | 180 × 105 | 328 | 293 | 22 | 0.9224 | 5 | 94.22% | 94.03% |
| | 6 | 150 × 105 | 328 | 293 | 2 | 0.0710 | 5 | 92.02% | 92.02% |
| | 7 | 120 × 105 | 328 | 293 | 23 | 0.4600 | 5 | 95.57% | 97.36% |
| | 8 | 105 × 105 | 328 | 292 | 1 | 0.0083 | 3 | 25.00% | 25.00% |
| | 9 | 270 × 105 | 328 | 294 | 1 | 0.1064 | 5 | 93.85% | 93.85% |
| | 10 | 240 × 105 | 328 | 294 | 4 | 0.3786 | 6 | 95.69% | 95.69% |
| | 11 | 210 × 105 | 328 | 293 | 4 | 0.2975 | 5 | 89.93% | 89.93% |
| | 12 | 180 × 105 | 328 | 293 | 3 | 0.1437 | 5 | 96.22% | 96.22% |
| | 13 | 150 × 105 | 328 | 293 | 8 | 0.3297 | 5 | 96.01% | 96.01% |
| | 14 | 120 × 105 | 328 | 293 | 11 | 0.2552 | 5 | 94.65% | 96.92% |
| | 15 | 105 × 105 | 328 | 292 | 15 | 0.3267 | 3 | 92.37% | 95.34% |
| | 16 | 210 × 105 | 328 | 293 | 3 | 0.2601 | 5 | 98.31% | 98.31% |
| | 17 | 105 × 105 | 49 | 7 | 4 | 0.1107 | 2 | 83.64% | 83.64% |
| | 18 | 90 × 90 | 49 | 7 | 28 | 0.4959 | 2 | 92.76% | 92.76% |
| | | | | | 199 | 6.7596 | | 94.45% | 94.60% |

TABLE 4
Comparison of allocation result (by residence)

| | | Product | | Yield | |
|---|---|---|---|---|---|
| | | | Timber | Present | |
| Name of | Number | | volume | application | Conventional |
| residence | of lots | Number | (m³) | FFD | method |
| Residence 1 | 16 | 201 | 6.902 | 93.80% | 93.37% |
| Residence 2 | 18 | 199 | 6.760 | 94.45% | 94.60% |
| Residence 3 | 19 | 257 | 9.538 | 93.71% | 93.30% |
| Residence 4 | 19 | 181 | 6.610 | 93.17% | 92.64% |
| Residence 5 | 17 | 136 | 5.144 | 93.72% | 92.76% |
| Residence 6 | 20 | 295 | 10.593 | 94.22% | 93.36% |
| Residence 7 | 16 | 162 | 5.976 | 92.71% | 92.30% |
| Residence 8 | 18 | 220 | 7.696 | 93.69% | 93.32% |
| Residence 9 | 15 | 214 | 6.788 | 94.08% | 93.29% |
| Residence 10 | 19 | 190 | 7.769 | 94.62% | 94.09% |

The yields of cases where only “standard 1” was applied and where “standard 2” and “standard 3” were further applied were compared in Table 5. In the columns of standard “2” and “3”, an “*” mark is given to the standard that became the cause of case where standard 1 and furthermore, two standards are applied and the yield enhanced. For example, in lot 1, 93.43% was obtained in standard 1, but 93.74% was obtained by applying standard 2. In lot 8, 95.87% was obtained with only the application of standard 1, but 96.89% was obtained by the re-estimation effect of standard 3.

TABLE 5
Comparison of standard combination result (by lot)

| [Residence 1] | | | | | | | [Residence 2] | | | | | | |
|---|---|---|---|---|---|---|---|---|---|---|---|---|---|
| | Number | Parent | | | | | | Number | Parent | | | | |
| | of | material | Standard | | | | | of | material | Standard | | | |
| Lot | products | Length type | 1 | 2 | 3 | Final yield | Lot | products | Length type | 1 | 2 | 3 | Final yield |
| 1 | 37 | 3 | 93.43% | * | | 93.74% | 1 | 38 | 3 | 94.64% | * | | 95.76% |
| 2 | 18 | 3 | 96.26% | | | 96.26% | 2 | 13 | 3 | 92.95% | | * | 96.34% |
| 3 | 3 | 5 | 89.97% | | | 89.97% | 3 | 14 | 6 | 97.36% | | | 97.36% |
| 4 | 17 | 6 | 95.60% | * | | 95.75% | 4 | 5 | 5 | 92.82% | | | 92.82% |
| 5 | 4 | 5 | 92.02% | | | 92.02% | 5 | 22 | 5 | 94.22% | | | 94.22% |
| 6 | 11 | 5 | 91.04% | * | | 94.36% | 6 | 2 | 5 | 92.02% | | | 92.02% |
| 7 | 1 | 5 | 29.13% | | | 29.13% | 7 | 23 | 5 | 90.82% | | * | 95.57% |
| 8 | 36 | 5 | 95.87% | | * | 96.89% | 8 | 1 | 3 | 25.00% | | | 25.00% |
| 9 | 9 | 3 | 92.84% | | | 92.84% | 9 | 1 | 5 | 93.85% | | | 93.85% |
| 10 | 6 | 5 | 95.56% | | | 95.56% | 10 | 4 | 6 | 95.69% | | | 95.69% |
| 11 | 8 | 5 | 92.97% | | | 92.97% | 11 | 4 | 5 | 89.93% | | | 89.93% |
| 12 | 3 | 5 | 93.89% | | * | 94.94% | 12 | 3 | 5 | 96.22% | | | 96.22% |
| 13 | 24 | 3 | 95.82% | | | 95.82% | 13 | 8 | 5 | 96.01% | | | 96.01% |
| 14 | 16 | 2 | 92.94% | | | 92.94% | 14 | 11 | 5 | 88.45% | | * | 94.65% |
| 15 | 2 | 2 | 63.71% | | | 63.71% | 15 | 15 | 3 | 92.37% | | | 92.37% |
| 16 | 6 | 2 | 84.02% | * | | 90.48% | 16 | 3 | 5 | 98.31% | | | 98.31% |
| | | | | | | | 17 | 4 | 2 | 83.64% | | | 83.64% |
| | | | | | | | 18 | 28 | 2 | 92.76% | | | 92.76% |
| | 201 | | 93.29% | 4 | 2 | 93.80% | | 199 | | 93.46% | 1 | 3 | 94.45% |

The yields of cases where only “standard 1” was applied and where “standard 2” and “standard 3” were further applied were compared by residence in Table 6. The number of lots with which the yield enhanced by application of two additional standards is shown in the columns of “2” and “3” by causative standard.

The application of standard combination is apparently found to be effective in enhancing the yield.

TABLE 6
Comparison of standard combination result
(by residence)

| | Number | Number of | Standard | | | |
|---|---|---|---|---|---|---|
| Residence | of lots | product | 1 | 2 | 3 | Final yield |
| Residence 1 | 16 | 201 | 93.29% | 4 | 2 | 93.80% |
| Residence 2 | 18 | 199 | 93.46% | 1 | 3 | 94.45% |
| Residence 3 | 19 | 257 | 92.91% | 3 | 3 | 93.71% |
| Residence 4 | 19 | 181 | 92.21% | 1 | 4 | 93.17% |
| Residence 5 | 17 | 136 | 93.26% | 0 | 4 | 93.72% |
| Residence 6 | 20 | 295 | 93.74% | 2 | 3 | 94.22% |
| Residence 7 | 16 | 162 | 90.79% | 1 | 6 | 92.71% |
| Residence 8 | 18 | 220 | 93.14% | 2 | 3 | 93.69% |
| Residence 9 | 15 | 214 | 93.64% | 1 | 1 | 94.08% |
| Residence 10 | 19 | 190 | 94.01% | 0 | 5 | 94.62% |

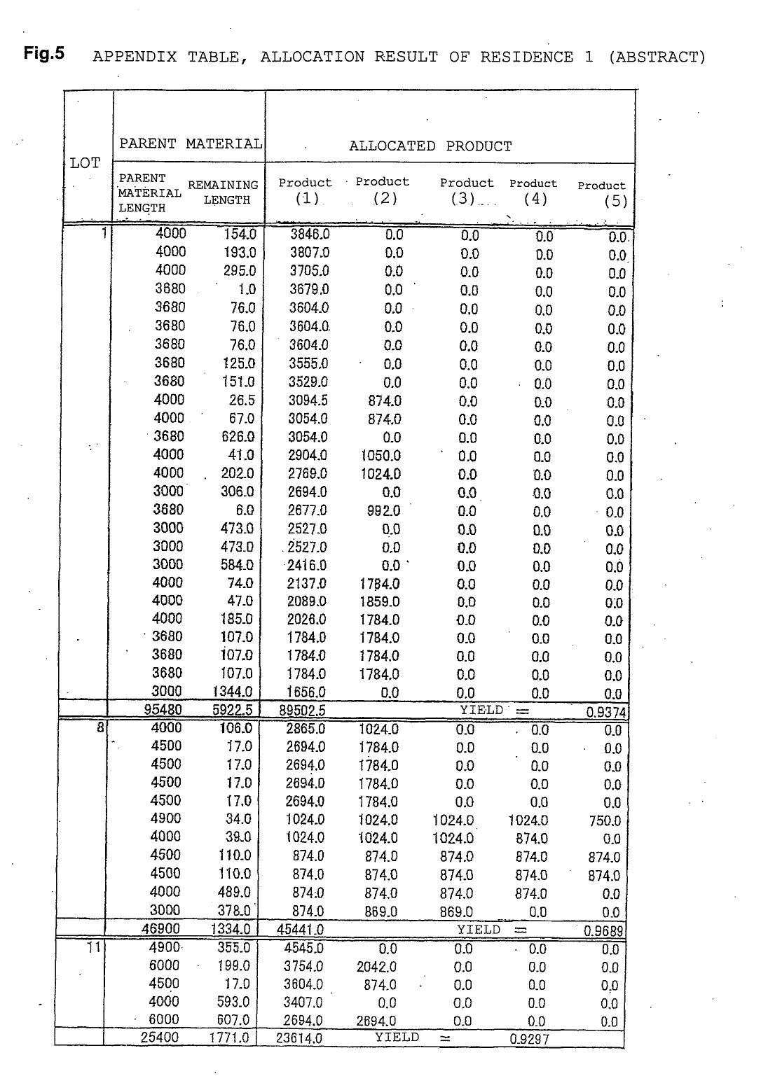

The allocation result in residence 1 is shown in FIG. 5 as an appendix Table 1.

In the above example, the case in which wood is the allocating target has been described, but the yield can be enhanced compared to the prior art in most cases by applying the allocating method of the present invention.

If the yield of the material can be enhanced, the material to use can be effectively used, whereby waste material that is not used can be further reduced and the resource can be effectively utilized.

A construction cost can be reduced, and efficiency in a transportation task of the parent materials can be enhanced since the amount of parent material to use to build one house can be reduced by enhancing the yield.

Furthermore, if the allocating method of the present invention is applied to the allocation of steel material, which unit price is higher than wood, the effect of reducing the material cost by enhancing the yield becomes greater than with wood.

For example, the cost can be greatly reduced in the entire business even if the yield is only slightly enhanced per one house to builders handling great amount of wood and steel material.

As described above, the allocating method of the present invention can obtain an appropriate allocation result in a short period of time close to substantially real time, where efficiency in the planning operation can be enhanced by again applying the allocating method of the present invention of short processing time even if sudden state change such as re-estimation of production planning, design change, or change of parent material group occurred, and rapid response can be made in accordance with such state change.

### INDUSTRIAL APPLICABILITY

In many precut factories where an operation based on the experience of expert employee is being carried out, the present algorithm can be considered as an effective method that can be easily and conveniently introduced and can obtain a result at high speed with a simple operation taking into consideration that the yield is less than or equal to 90%.

The proposed modified FFD of the present application can be applied in many ways such as to loading assortment of packages to a truck of a plurality of carrying capacities.

1. A precut material allocating method for allocating a plurality of products having a predetermined size to a parent material group composed of a plurality of parent materials of different sizes, the method comprising:
a sorting step of arraying the plurality of products in order of the sizes;
a tentative allocation step of extracting the individual products in the array order and allocating the extracted products tentatively to the individual parent materials belonging to the parent material group, thereby to establish a plurality of tentative allocation states;
a first standard step of selecting the tentative allocation state, in which a yield of the parent material used in the allocation is the highest, of the plurality tentative allocation states established, as an allocation candidate;
a second standard step of selecting the tentative allocation state, in which the total of the remaining sizes of all parent materials used for the allocation is the smallest, of the plurality tentative allocation states established, as the allocation candidate; and
a third standard step of comparing the selected tentative allocation state and the remaining allocation states, for the tentative allocation states individually selected at the first and second standard steps, in a case where predetermined tentative allocation conditions are satisfied at the first standard step and the second standard step, thereby to select again the tentative allocation state, in which the total of the sizes of the individual parent materials used is the minimum, as the allocation candidate.

2. The precut material allocating method according to claim 1, wherein
the predetermined tentative allocation conditions include,
checking whether a minimum value of a total size of non-allocated products for each of the established tentative allocation states after tentatively allocating a predetermined number of products to the parent material group is smaller than or equal to a size of a parent material having a largest size belonging to the parent material group at the first and second standard steps, and
performing the third standard step in a case where the total size of the non-allocated products is smaller than or equal to the size of the parent material having the largest size, and not performing the third standard step otherwise.

3. The precut material allocating method according to claim 1, wherein
the first standard step includes,
a first calculation step of calculating a material yield, obtained by dividing the total size of the products allocated to each parent material used in the tentative allocation by the size of the parent material, for each tentative allocation state established in the tentative allocation step, and
a first selection step of selecting the tentative allocation state in which the calculated material yield with respect to each allocation state is the largest as a tentative allocation state in which the yield is the highest.

4. The precut material allocating method according to claim 1, wherein
the second standard step includes,
a second calculation step of calculating a remaining material size of a portion not allocated with products for each parent material used in the tentative allocation, with respect to each tentative allocation state established in the tentative allocation step, and
a second selection step of selecting the tentative allocation state in which the remaining material size is the smallest of the calculated remaining material sizes of each tentative allocation state as a selection candidate.

5. The precut material allocating method according to claim 1, further comprising:
a first yield calculation step of calculating a yield y 1 obtained by dividing a total size of all products to be allocated by the total size of all parent materials used in the tentative allocation, with respect to the allocation candidate selected in the first standard step;
a second yield calculation step of calculating a yield y2 obtained by dividing a total size of all products to be allocated by the total size of all parent materials used in the tentative allocation, with respect to the allocation candidate selected in the second standard step;
a step of comparing the yield y 1 and the yield y2; and
an allocation determination step of determining the allocation candidate of larger yield, as a result of the comparison, as the final allocation state.

6. The precut material allocating method according to claim 1, wherein in the tentative allocation step, in a case where a size of one retrieved product is smaller than or equal to a size of one parent material when tentatively allocating the retrieved product to the parent material, or the total size of the size of the retrieved product and the sizes of all tentatively allocated products is smaller than or equal to the size of the parent material when one or a plurality of products is already tentatively allocated to the parent material, the retrieved product is tentatively allocated to the parent material.

7. The precut material allocating method according to claim 1, wherein the sizes of the parent material and the product are lengths in a one-dimensional direction in a case where the parent material and the product are materials long in the one-dimensional direction.

8. The precut material allocating method according to claim 1, wherein the parent material and the product are one-dimensional members or two-dimensional members.

9. The precut material allocating method according to claim 8, wherein the one-dimensional member is wood.

10. The precut material allocating method according to claim 8, wherein the two-dimensional member is a steel plate, a cloth member, or a paper member.

11. A program for causing a computer to execute each step of a precut material allocating method according to claim 1.

12. A computer-readable recording medium recording a program according to claim 11.
